(19) United States
(12) Patent Application Publication
(10) Pub. No.: US 2001/0019317 A1
(43) Pub. Date: Sep. 6, 2001

(54) Method of driving a plasma display panel

(76) Inventors: Alexis Seguin, Grenoble (FR); Philippe Zorzan, Grenoble (FR)

Correspondence Address: Joseph S. Tripoli, THOMSON Multimedia Licensing Inc., Two Independence Way, P.O. Box 5312, Princeton, NJ, 08543-5312, US

(21) Appl. No.: 09/795,029

(22) Filed: Feb. 27, 2001

(30) Foreign Application Priority Data
Mar. 6, 2000 (FR) 0002863

(51) Int. Cl. G09G 3/28

(52) U.S. Cl. 345/60

(57) ABSTRACT

According to the invention, the method of driving a plasma display panel uses a preconditioning ionization during each subscan with a reduced light background. This method applies to the display-while-addressing mode in which ionization pulses IP, address pulses AP and erase pulses EP are superimposed on a sustain signal common to all the lines of a PDP. The sustain signal according to the invention is a signal which comprises at least four levels L1 to L4, two successive levels L1 and L2 of which allow an ionization pulse IP and an erase pulse EP to be superimposed, respectively.

### BACKGROUND OF THE INVENTION

1. Field of the Invention

The invention relates to a method of driving a plasma display panel, and more particularly panels which are displayed in so-called “addressing-while-displaying” mode.

2. Description of the Prior Art

Plasma display panels, called hereafter PDPs, are flat display screens. There are two large families of PDPs namely PDPs whose operation is of the DC type and those whose operation is of the AC type. In general, PDPs comprise two insulating tiles (or substrates), each carrying one or more arrays of electrodes and defining between them a gas-filled space. The tiles are joined together so as to define intersections between the electrodes of the said arrays. Each electrode intersection defines an elementary cell to which a gas space partially bounded by barriers corresponds and in which an electrical discharge occurs when the cell is activated. The electrical discharge emits UV rays in the elementary cell and phosphors deposited on the walls of the cell convert the UV rays into visible light.

In the case of AC type PDPs, there are two types of cell architecture, one called a matrix architecture and the other called a coplanar architecture. Although these cells are different, the operation of an elementary cell is substantially the same. Each cell may be in the ignited or “on” state or in the extinguished or “off” state. A cell may be maintained in one of these states by sending a succession of pulses, called sustain pulses, throughout the duration over which it is desired to maintain this state. A cell is turned on, or addressed, by sending a larger pulse, usually called an address pulse. A cell is turned off, or erased, by nullifying the charges within the cell using a damped discharge. To obtain various grey levels, use is made of the eye's integration phenomenon by modulating the durations of the on and off states using subscans, or subframes, over the duration of display of an image.

In order to be able to achieve temporal ignition modulation of each elementary cell, two so-called “addressing modes” are mainly used. A first addressing mode, called “addressing while displaying”, consists in addressing each row of cells while sustaining the other rows of cells, the addressing taking place row by row in a shifted manner. A second addressing mode, called “addressing and display separation”, consists in addressing, sustaining and erasing all of the cells of the panel during three separate periods.

The international patent application published under the number WO 99/17269 (hereafter called D1) discloses a method of driving a PDP in addressing-while-displaying mode. D1 discloses a system using a PDP with a matrix structure, an example of which is shown in FIG. 1. The matrix panels comprise a plurality of luminous cells C arranged in rows and columns. A cell C corresponds to an intersection between a row electrode Y1 to Y16 and a column electrode X1 to X27.

The display method used in D1 is shown schematically in FIG. 2. By way of example, the panel has only seven grey levels between 0 and 7. Since the cells can only be either on or off, the grey levels are obtained by temporal integration of the illumination time of each cell. Thus, to display an image with eight grey levels for a period T, subscans of duration T/7, 2T/7 and 4T/7, which correspond to the illumination weights 20, 21 and 22 respectively, are used. During each subscan, the cells are selectively turned on or turned off. The principle of addressing while displaying consists in addressing cells, that is to say in switching them into the on state or off state, while other cells are sustained, that is to say maintained in their on state or off state. In FIG. 2, the cells are addressed in groups of four rows.

FIG. 3 shows the signals employed. A row signal SYi consists of a sustain signal, shown as a solid line, to which address pulses AP, ionization pulses IP and erase pulses EP are added, these being shown in dotted lines. A column signal SXi consists of a series of mask pulses MP synchronized with the address pulses AP so as to mask, or not, the said address pulses AP in the cells of the row addressed. To produce the circuits which combine these signals, a person skilled in the art should refer to D1.

The sustain signal is a cyclic signal which comprises a high level HL and a low level LL. The voltage of the high level HL is generally between 160 and 220 V and the voltage of the low level LL is between 160 and −220 V. The voltage variation range depends on many parameters, among which is the structure of the PDP cells. A sudden switch from the high level HL to the low level LL or from the low level LL to the high level HL produces a sustain discharge in the previously ionized cells. In the example, an intermediate level of short duration appears, this being essentially due to the construction of the drive circuits; this intermediate level is as short as possible and could be eliminated.

The address pulses AP are added to a high level so as to create a ionization of the gas intended to bring the cells into the on state. An address pulse AP is used only on a single row so as to select the said row from the plurality of rows of the PDP. The amplitude of an address pulse AP is generally between 30 and 120 V and lasts about 1 to 3 Ps. The amplitude and the duration of a pulse are linked parameters which also depend on the structure of the PDP cell. The mask pulses MP are synchronized with the address pulses AP. The amplitude of the mask pulses MP is less than or equal to the amplitude of the address pulses AP. The duration of the mask pulses MP is greater than or equal to the duration of an address pulse AP. A mask pulse MP is present on a column electrode when the cell corresponding to the selected row must remain in the off state. The function of the mask pulse MP, when it is present, is to nullify the effect of the masked address pulse AP.

The erase pulses EP produce a slow discharge of the cells, which nullifies the memory charges (or residual surface charges) and place the cells in the off state.

It is possible to produce a panel using only address pulses AP, mask pulses MP and erase pulses EP. For the sake of saving energy and of maximizing the address time (fixed by the display time of an image according to the number of subscans and to the number of rows in the panel), it is necessary to produce as far as possible the amplitude and the duration of the address pulses. A problem of the cells not being turned on may occur if the amplitude and the duration of the address pulses are too close to the operating limits. The ionization time needed for an addressing step depends on the localized residual ionization in the cell to be turned on. It proves to be the case that the time needed to turn on a cell which has not been turned on for a long period is longer than for a cell which has just been turned off. In addition, the phenomena of outgassing of materials may affect one region of the PDP, increasing the time needed to turn on a cell.

The ionization pulses IP are used to regularly turn on all the cells of the PDP before erasure so as to ensure a minimum residual ionization of the cells. The effect of adding the ionization pulses IP is to ensure greater homogeneity in turning on the cells and makes it possible to reduce the duration of the address pulses AP. The duration and the amplitude of the ionization pulses IP may be greater than or equal to the duration and the amplitude of the address pulses AP, respectively.

FIG. 4 shows a timing diagram for using the addressing technique in the cells placed at the intersections of the row electrodes Y5 and Y6 with the column electrode X4. The signals SY5, SY6 and SX4 correspond to the signals sent to the row electrodes Y5 and Y6 and to the column electrode X4, respectively. The signals SY5-SX4 and SY6-SX4 correspond to the potential differences present in the cells.

Over the time Ta, the cells are in the on state or off state. Over the time Tb, the group of four rows comprising the rows Y5 and Y6 receives an ionization pulse which has the effect of switching all the cells of the four rows into the on state. The time Tc corresponds to a sustain period during which two sustain discharges are produced so that the ionization is homogeneous in all the cells of the four rows. Over the time Td, an erase discharge nullifies the memory charges so that all the cells of the four rows return to the off state. The time Te corresponds to the cells of the row Y5 being addressed; since the signal SX4 has a pulse at the same time, the voltage in the cell placed at the intersection of the row Y5 with the column X4 does not exceed the ionization threshold needed for turning the cell on, which remains in the off state. The time Tf corresponds to the cells of the row Y6 being addressed; since the signal SX4 does not have a pulse of the same nature, the voltage in the cell placed at the intersection of the row Y6 with the column X4 exceeds the ionization threshold needed to turn a cell on, this having the effect of turning the cell on. Over the time Tg, the rows Y7 and Y8 are addressed. Over the time Th, sustain periods follow one another so as to illuminate the cell for a time proportional to the illumination weight of a subscan.

A person skilled in the art may notice that during the high levels, pulses corresponding to mask pulses appear in all the cells. Although these pulses seem to be of large amplitude in the drawings, their amplitude is less than the voltage necessary for a sustain pulse to be produced. In addition, the duration of these pulses is short enough not to reduce the ionization of the cells.

FIG. 5 gives a more general picture of the signals present on the row electrodes of a PDP corresponding to FIG. 1 and driven as indicated in FIG. 2 using the method disclosed in D1. In this figure, a single ionization per image is produced. D1 indicates that the ionization may occur several times per image, for example two or three times for an image displayed using eight or ten subscans.

To improve the cell turn-on effectiveness, it is desirable for ionization to take place before each subscan. The signals of the prior art therefore introduce a light background as shown in FIG. 6. In our example, an ionization sustain cycle IS comprising two sustain discharges is used. The sustain cycle is repeated three times per image since three subscans are used. The light background introduced corresponds to six sustain discharges plus three ionization discharges and three erase discharges, i.e. a total of twelve discharges. Moreover, the low-weight subscan sustain LWS corresponds to only four discharges. The light background level is then above the minimum grey level resolution.

Transposing to a PDP intended to be used in television, that is to say comprising 480 or 560 lines and using ten subscans, the low-weight subscan sustain corresponds, for example, to ten sustain discharges. The use of an ionization at each subscan has the effect of adding 40 discharges (20 sustain discharges, 10 ionization discharges and 10 erase discharges) in the permanent light background, which corresponds to a contrast of about 70:1, that is to say a mediocre contrast.

A person skilled in the art might be tempted to eliminate the ionization sustain cycle IS so as to sequence the erasure just after ionization. However, trials show that simply eliminating the sustain cycle does not make it possible to obtain either effective ionization or effective erasure. In order to have proper operation with an erase pulse EP placed immediately after an ionization pulse IP, the durations of these two pulses EP and IP must be increased. However, the maximum period of the sustain signal SP is determined by the number of subscans N_{S}, the number of rows in the panel N_{R}, the number of rows addressed within the same group N_{G} and the display time T_{dis} of an image through the following equation: SP=(T_{dis}×N_{G})/(N_{S}×N_{R}). It is known to vary the number of rows addressed within the same group in order to be able to vary the period of the sustain signal. However, increasing the period of the sustain signal has the undesirable result of reducing the number of sustain periods and therefore of reducing the maximum luminosity of the panel. Increasing the turn-on effectiveness amounts to reducing the maximum luminosity of the PDP.

### SUMMARY OF THE INVENTION

A first objective of the invention is to reduce the light background produced by an ionization so as to make it possible to increase the number of ionizations without reducing the luminosity of the panel. A second objective of the invention is to increase the luminosity of a PDP. To achieve the desired objectives, the invention provides a novel form of sustain signal on which the ionization, address and erase pulses are superimposed. The sustain signal according to the invention is a signal which comprises at least four levels, three levels of which allow an ionization pulse, an erase pulse and address pulses to be superimposed, respectively. According to the invention, the level supporting the erase pulse is placed immediately after the level supporting the ionization pulse.

The invention is a method for driving a plasma display panel, of the AC type, which comprises two sealed tiles spaced apart so as to define a cavity between them, one of the tiles supporting column electrodes and the other supporting row electrodes. Illumination cells are located in the cavity, each cell being placed at the intersection of a column electrode with at least one row electrode. At least one signal generator delivers to the row electrodes a sustain signal to which ionization pulses, erase pulses and address pulses are added. The ionization and erase pulses are added simultaneously to the sustain signals for at least two rows and the address pulses are added simultaneously to a sole row. The sustain signal is a periodic signal which includes at least first to fourth levels joined by transitions intended to cause sustain discharges. A first level is immediately followed by a second level and the second level is immediately followed by a third level. The ionization pulses are added to the first levels and the erase pulses are added to the second levels.

Ionization pulses should be understood by a person skilled in the art to mean the pulses causing a preconditioning ionization, also called priming ionization. It goes without saying that the address pulses also cause ionization of the gas in the panel, but the term “ionization pulses” refers only to the pulses intended to ionize the gas before a cell is erased so as to guarantee a homogeneous residual ionization for the cells of a PDP before an address pulse intended to place the cells in the on state is received.

The use of four levels per sustain cycle allows cycles of longer duration to be used than in the prior art while still having a high number of sustain discharges. Decoupling the ionization pulses from the sustain pulses furthermore provides better reliability than in the prior art. Considering that it is not necessary to double the period of a sustain cycle to obtain good reliability, this makes it possible at the same time to increase the maximum luminosity of a PDP.

According to one method of implementation, the sustain signal furthermore includes fifth and sixth levels, the fourth, the fifth and the sixth level being placed after the third level and before a next first level. The first, third and fifth levels correspond to a first voltage and the second, fourth and sixth levels correspond to a second voltage. Adding the fifth and sixth levels makes it possible to increase the maximum luminosity of the panel.

Preferably, the address pulses are added to the third levels so as to have the maximum number of discharges per subscan.

The invention also relates to a plasma display panel, of the AC type, which comprises two sealed tiles spaced apart so as to define a cavity between them, one of the tiles supporting column electrodes and the other supporting row electrodes. Illumination cells are located in the cavity, each cell being placed at the intersection of a column electrode with at least one row electrode. At least one signal generator delivers to the row electrodes a sustain signal to which ionization pulses, erase pulses and address pulses are added. The ionization and erase pulses are added simultaneously to the sustain signals for at least two rows and the address pulses are added simultaneously to a sole row. The sustain signal is a periodic signal which includes at least first to fourth levels joined by transitions intended to cause sustain discharges. A first level is immediately followed by a second level and the second level is immediately followed by a third level. The ionization pulses are added to the first levels and the erase pulses are added to the second levels.

### BRIEF DESCRIPTION OF THE DRAWINGS

The invention will be more clearly understood and further features and advantages will become apparent on reading the description which follows, this being given with reference to the appended drawings in which:

FIG. 1 shows an arrangement of luminous cells of a plasma display panel;

FIG. 2 is a timing diagram showing the temporal distribution of the subscans in addressing-while-displaying mode;

FIGS. 3 to 6 show the drive signals for the electrodes of a plasma display panel according to the prior art;

FIGS. 7 to 9 show the drive signals for the electrodes of a plasma panel according to a first method of implementing the invention;

FIG. 10 shows a table comparing the invention with the prior art;

FIG. 11 shows an example of circuitry for implementing the invention; and

FIGS. 12 to 15 show the drive signals for the electrodes of a plasma panel according to another method of implementing the invention.

### DETAILED DESCRIPTION OF PREFERED EMBODIMENTS

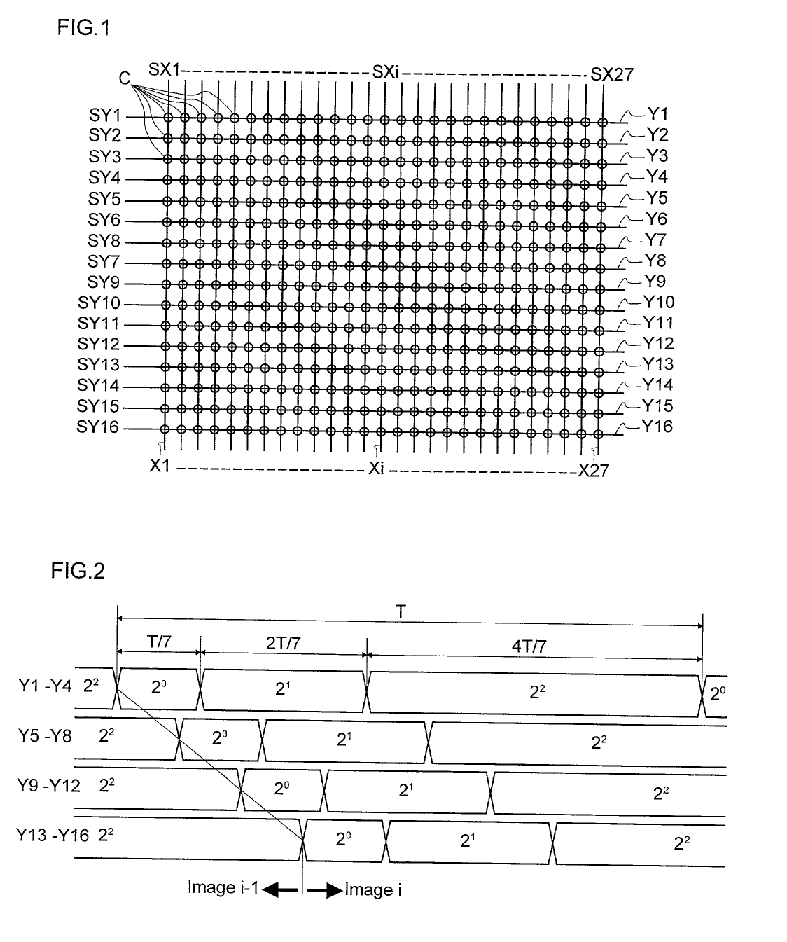

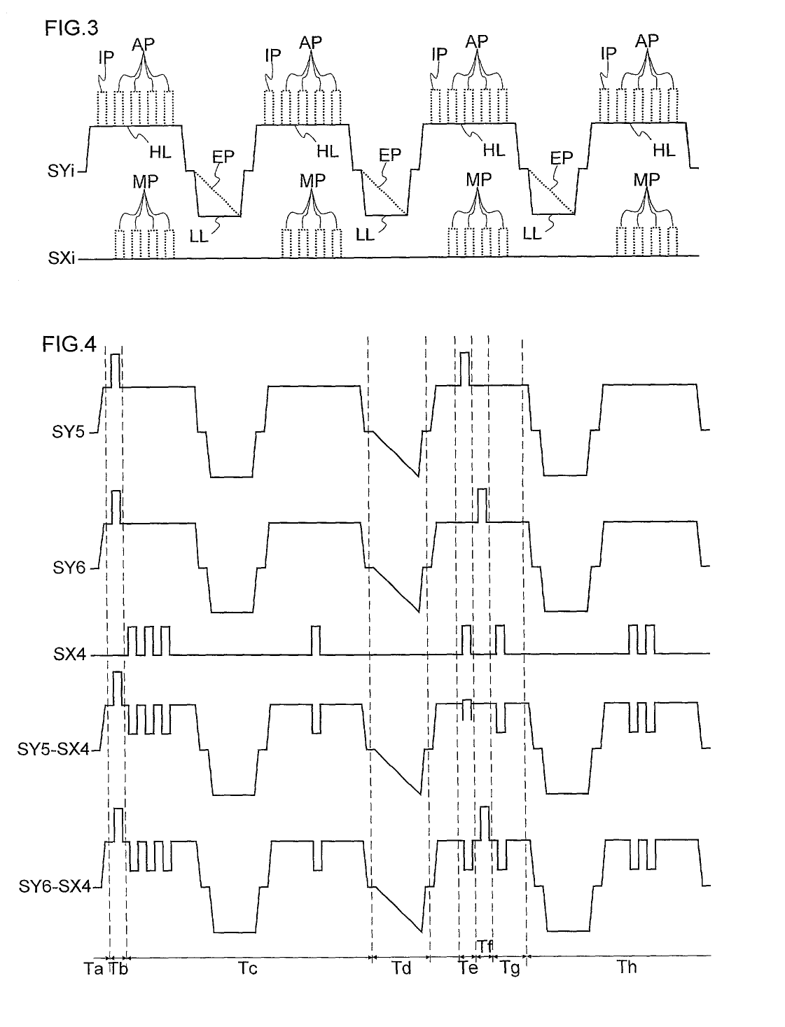

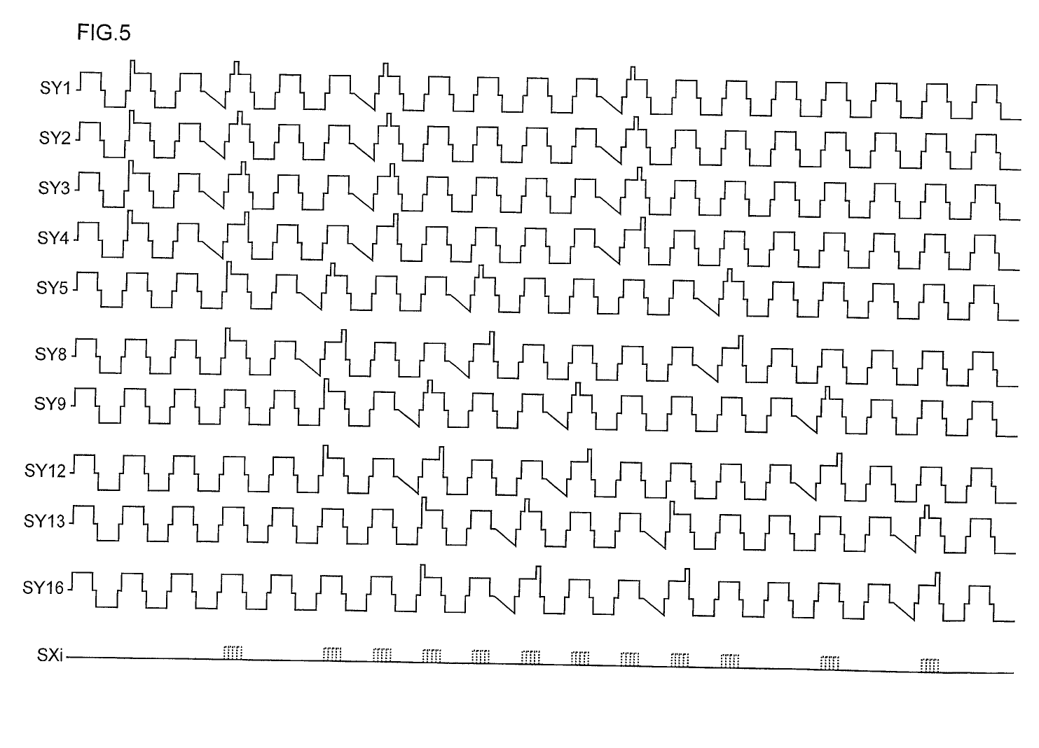

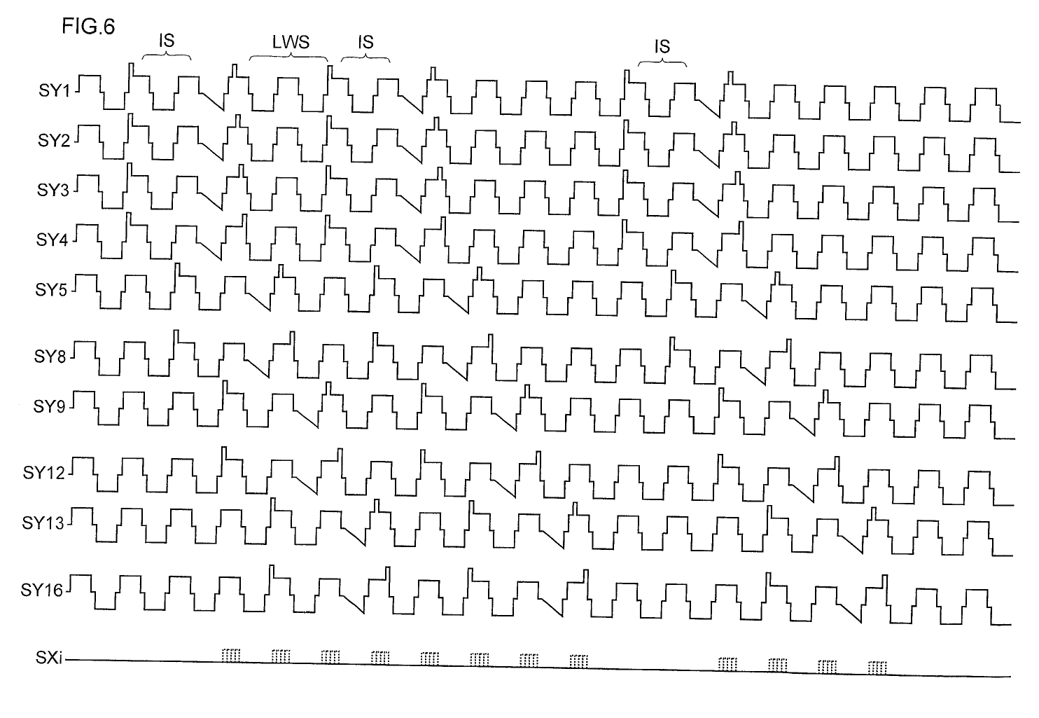

The various figures showing timing diagrams are not given to scale so as to make certain details more apparent, which would not appear so clearly if the proportions had been respected. For the purpose of explanation and comparison, the various signals used in the invention correspond to the PDP in FIG. 1, which uses the addressing mode described in FIG. 2. Furthermore, in order to simplify the description and bring out the differences and advantages of the invention over the prior art, the same references are used for the components fulfilling the same function.

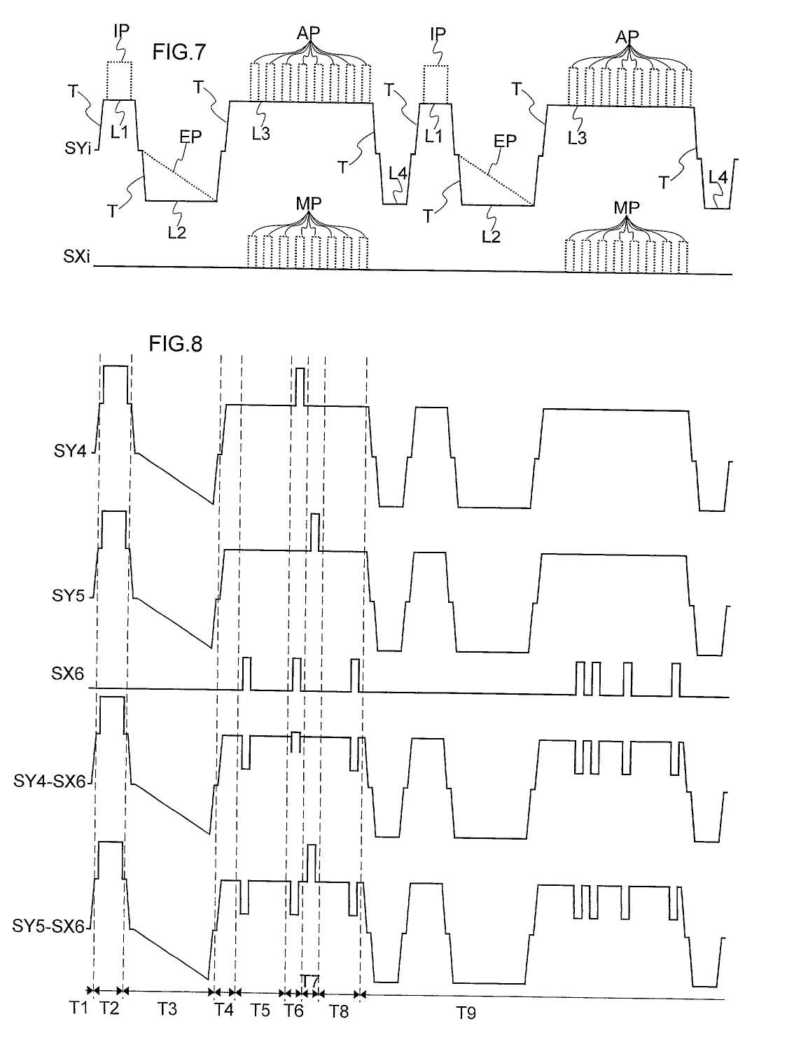

A first method of implementing the invention will be described with reference to FIGS. 7 to 9.

FIG. 7 shows the drive signals used in the invention. The row signal SYi consists of a sustain signal which comprises first to fourth levels L1 to L4 joined by transitions T. A first level L1 is followed by a second level L2, then by a third level L3, then by a fourth level L4 and again by a first level L1, etc. The first and third levels correspond to the same first voltage level, for example between 160 and 220 V. The second and fourth levels correspond to the same second voltage level, for example between 160 and −220 V.

Ionization pulses IP, erase pulses EP and address pulses AP are added to the row signals so as to turn the cells C of the PDP on and off. The ionization pulses IP are added to the first levels L1. The erase pulses EP are added to the second levels L2. The address pulses are added, for example, to the third levels L3.

A column signal SXi consists of a series of mask pulses MP synchronized with the address pulses AP.

The arrangement of the pulses distributed over the three different levels increases the number of sustain discharges per cycle of the sustain signal. In the present example with four levels, there are four discharges per cycle instead of two discharges in the prior art. The doubling of the number of discharges and of the number of address pulses per sustain cycle makes it possible to use half the number of sustain cycles for a constant luminosity and for a constant number of rows addressed, while still increasing the duration of the ionization pulses IP, the duration of the erase pulses EP and the number of address pulses AP per cycle.

By way of example, for a 560-line PDP using 10 subscans with images refreshed with a frequency of 50 Hz, addressing in groups of eight rows forces a sustain cycle to have the maximum duration of 28.5 μs. With such a cycle time, it is easy to have an ionization pulse IP of about 3 μs, an erase pulse EP of about 7 μs and a series of address pulses AP over a time of about 14 μs. The transitions T each take about 0.3 μs and the fourth level lasts about 3 μs. As a comparison, the signals of the prior art described above, which correspond to the same luminosity, would only allow for a 1.9 μs ionization pulse with a 4.8 μs erase pulse.

Increasing the duration of the ionization pulse IP makes it possible to have immediate erasure after the ionization, which is effective for obtaining the minimum level of residual ionization and for ensuring proper erasure. The light background is reduced to the minimum possible, namely one possible discharge at the start of erasure if the priming voltage is very high.

FIG. 8 shows a timing diagram used in the addressing technique according to the invention in the cells placed at the intersections of the row electrodes Y4 and Y5 with the column electrode X6. The signals SY4, SY5 and SX6 correspond to the signals sent to the row electrodes Y4 and Y5 and to the columns electrode X6, respectively. The signals SY4-SX6 and SY5-SX6 correspond to the potential differences present in the cells.

Over the time T1, the cells are in the on state or off state. Over the time T2, the group of eight rows including the rows Y4 and Y5 receives an ionization pulse whose effect is to ionize the gas contained in the cells of the eight rows, the cells switching to the on state. Over the time T3, the group of eight rows receives an erase pulse which greatly reduces the ionization so that the cells of the eight rows return to the off state. The time T4 separates the erase pulse from the first address pulse so as to have the optimum discharge range over a time from 1.5 to 2 μs for the PDP lines which are in sustain phase. Over the time T5, the rows Y1 to Y3 are addressed in succession. The time T6 corresponds to the cells of the row Y4 being addressed; since the signal SX6 has a simultaneous mask pulse, the voltage in the cell placed at the intersection of the row Y4 with the column X6 does not exceed the voltage threshold needed to ionize the gas, the cell remaining off. The time T7 corresponds to the cells of the row Y5 being addressed; since the signal SX6 does not have a mask pulse, the voltage in the cell placed at the intersection of the row Y5 with the column X6 exceeds the voltage threshold needed to ionize the gas, with the effect that the cell switches to the on state. Over the time T8, the rows Y6 to Y8 are addressed. Over the time T9, sustain periods follow one another so as to illuminate the cells of the group of eight rows over a time proportional to the illumination weight of a subscan. Over the time T9, another group of rows will undergo ionizing-erasing-addressing operations.

A person skilled in the art may notice that during the third levels, pulses corresponding to mask pulses appear in all the cells. Although these pulses seem to have a large amplitude in the drawings, their amplitudes are less than the voltage needed for a sustain discharge to be produced. In addition, the duration of these pulses is short enough not to reduce the ionization of the cells. However, it is preferable not to place an address pulse within the optimum discharge range located at the start of the third level, since, if an address pulse were to occur during this range, the sustain discharge may be affected and may produce a less bright arc.

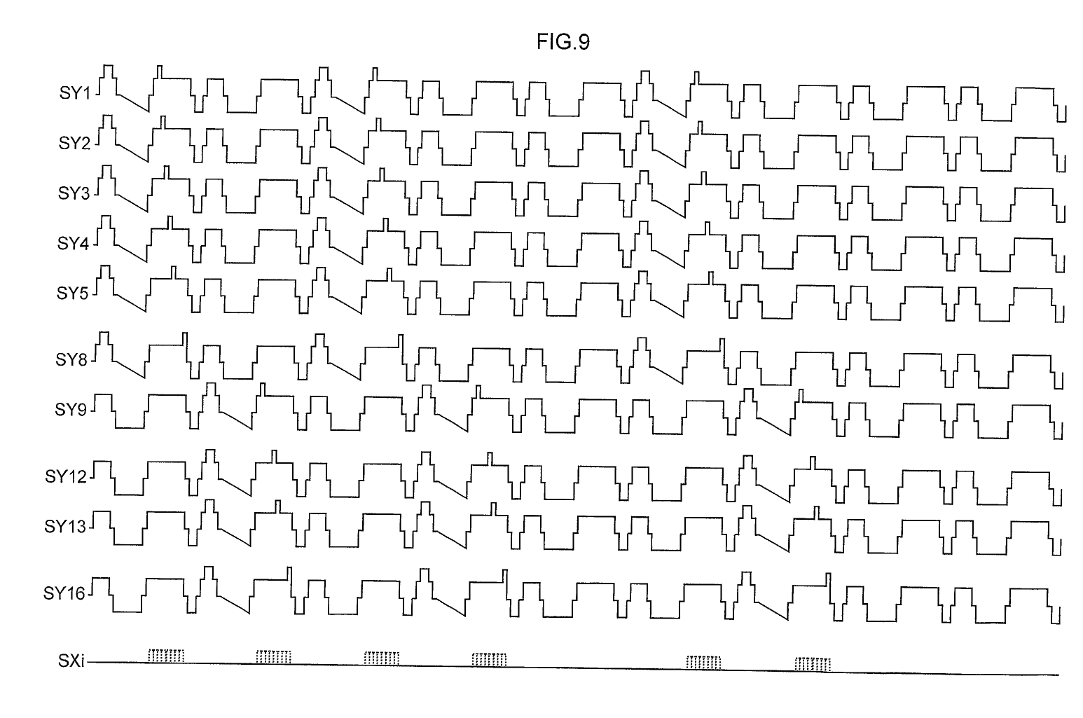

FIG. 9 gives a more general picture of the signals present on the row electrodes of a PDP corresponding, for example, to the PDP in FIG. 1. A person skilled in the art will notice that it is possible to produce an ionization discharge at each subscan with a reduced light background.

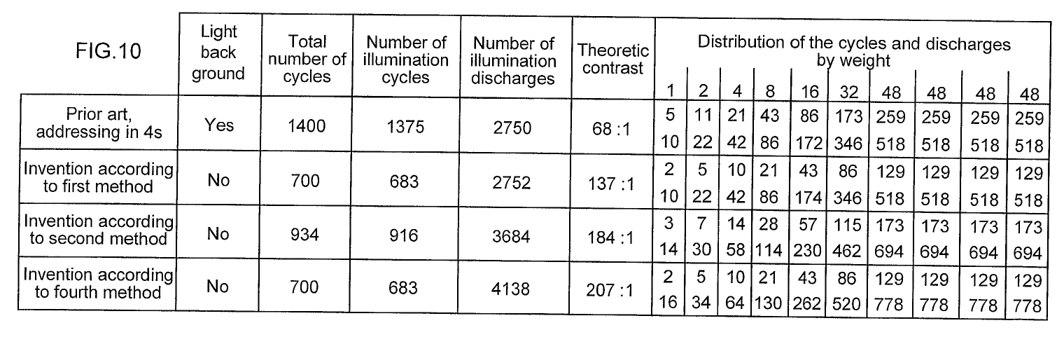

The table in FIG. 10 provides a comparison between the prior art described using groups of four rows with the first embodiment of the invention. This table is drawn up for a panel comprising 560 lines with a refresh rate of 50 images per second using ten subscans. For this comparison, an ionization takes place during subscans so as to compare devices of equivalent reliability. The prior art with addressing by groups of four rows requires the use of an ionization sustain cycle in order to be able to ensure good reliability.

In the table it may be seen that the total number of cycles corresponds to the minimum number of cycles needed to be able to address all the lines of a PDP. The number of illumination cycles corresponds to the number of cycles actually used to sustain a subscan. The number of illumination discharges corresponds to the maximum number of discharges that can be produced in a cell illuminated to the maximum, the number of discharges being proportional to the luminosity. The distribution of the cycles and discharges per weight indicates in the upper part of the boxes the number of sustain cycles associated with the subscan of illumination weight indicated, the lower part indicating the corresponding number of discharges. The ratio of the illumination weight to the number of discharges is not exactly proportional for rounding reasons. This non-proportionality is a phenomenon known to a person skilled in the art, who seeks moreover to minimize as far as possible the effects which may stem therefrom.

As explained above, the prior art using addressing in groups of four rows has a light background, especially due to the 20 sustain discharges located between the ionization and erase discharges, which corresponds to a theoretical contrast of 68:1 in the example given in the table.

The first method of implementing the invention solves the problem of the light background coming from the 20 sustain discharges, while still retaining a number of discharges almost the same as the number of discharges obtained in the prior art with addressing in groups of four rows. The theoretical contrast is twice as good.

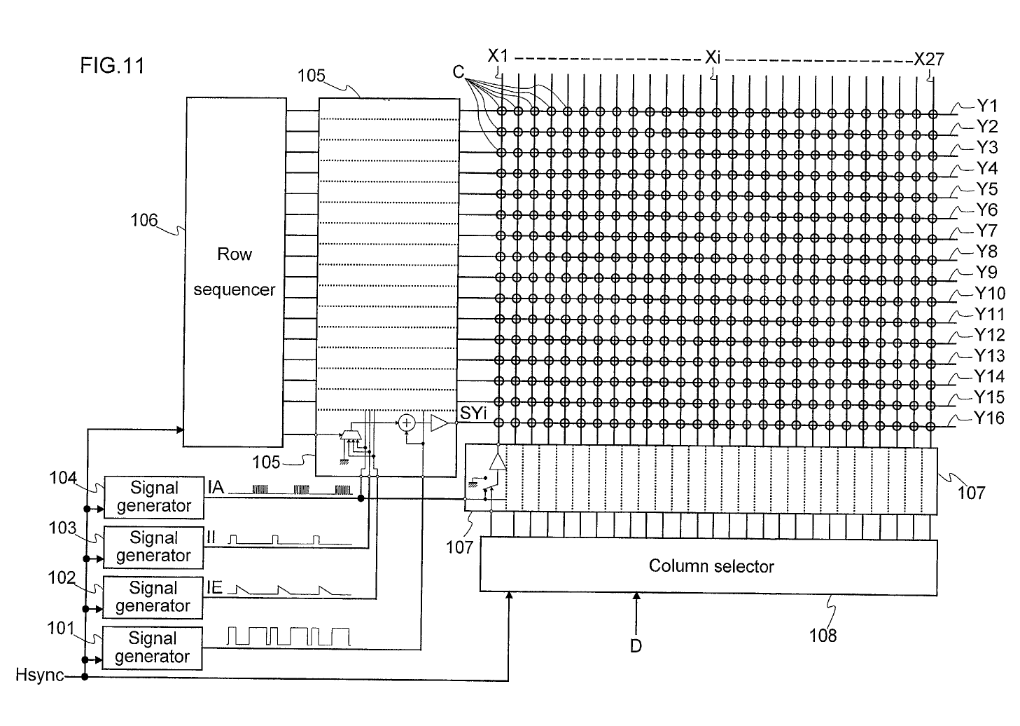

The first method is implemented using a technique similar to the prior art. FIG. 11 illustrates one embodiment. A first signal generator 101 delivers the sustain signal. A second signal generator 102 delivers a series of erase pulses EP. A third signal generator 103 delivers a series of ionization pulses IP. A fourth signal generator 104 delivers a series of address pulses AP. The first to fourth generators 101 to 104 also receive a clock signal Hsync of frequency greater than the cycle frequency of the sustain signal so as to synchronize generation of the pulses with the sustain signal. In the example shown, a plurality of signal generators is used but it goes without saying that a single generator can deliver all the signals to the various outputs. It is also possible to deliver a single signal corresponding to the sum of the ionization IP, erase EP and address AP signals since the various pulses are not overlapping.

Row drive circuits 105 each receive the signals output by the first to fourth generators 101 to 104 and a select signal output by a sequencer 106 so as to deliver a row signal SYi to a row electrode Y1. Each drive circuit 105 includes an analogue selection means for selecting, when necessary, an ionization pulse IP, an erase pulse EP or an address pulse AP depending on the select signal. Each row drive circuit 105 furthermore includes an analogue circuit for adding the signal output by the selection means to the sustain signal and an amplification means for amplifying the signal resulting from the signal addition so as to deliver the row signal SYi. The sequencer 106 receives the clock signal Hsync so as to be synchronized with the sustain signal. The clock signal Hsync, if it has a high enough frequency, can also serve as rate signal for the sequencer 106.

Column drive circuits 107 each receive the signal output by the fourth generator 104 and a select signal output by a column selector 108 so as to deliver a column signal SXi to the column electrode Xi. Each column drive circuit 107 includes an analogue selection means for selecting, when necessary, an address pulse AP depending on the select signal, the address pulse then becoming a mask pulse. Each column drive circuit 107 furthermore includes an amplification means for amplifying the signal output by the selection means so as to deliver the column signal SXi. The column selector receives, on the one hand, the clock signal Hsync so as to be synchronized with the sustain signal and, on the other hand, one or more data signals D. The data signals are binary information indicating if the cells of the next row have to be turned on or not. The column selector stores the data relating to the next row in buffer registers while the current row is being displayed and then, when the next row becomes the current row, the data is used as select signals. The clock signal Hsync, if it has a high enough frequency, can also serve as rate signal for the column selector 108.

The first method of implementation does indeed improve the prior art, but it is not optimized. This is because, in the first method of implementation the durations of the various levels may be shorter for the same result.

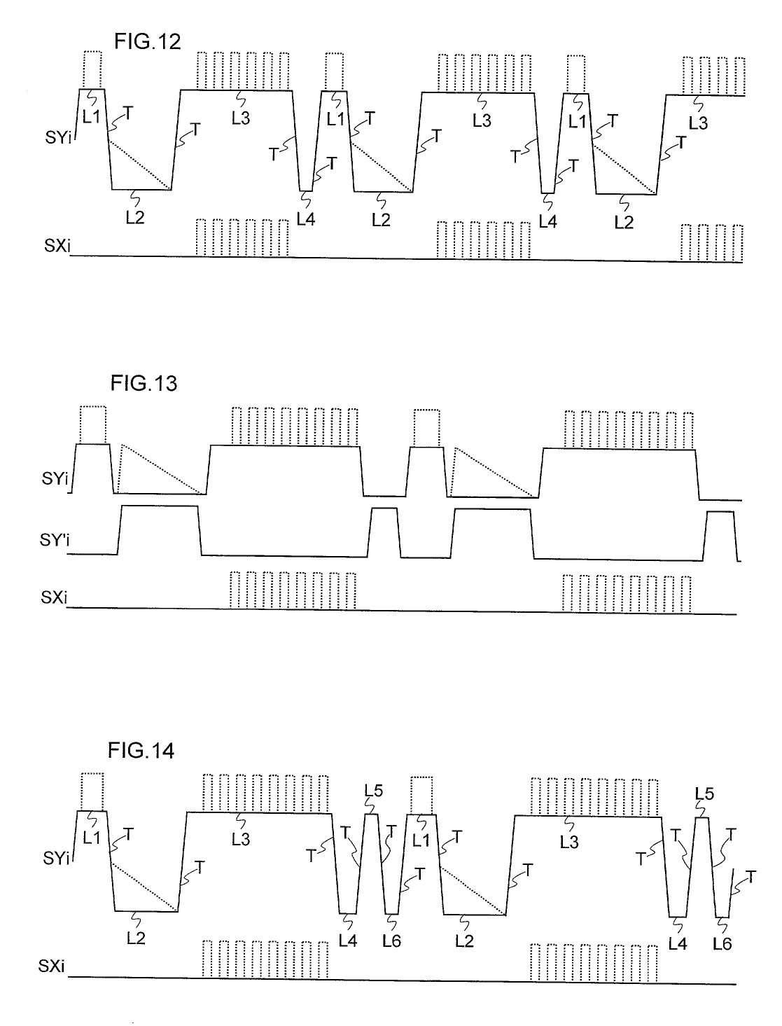

According to a second method of implementing the invention, addressing takes place in groups of six rows, as shown in FIG. 12. This addressing in groups of six rows requires the ionization and erase times to be reduced but allows the durations to be long enough to be able to erase immediately after an ionization. As an example, for a 560-line PDP using 10 subscans with images refreshed at a frequency of 50 Hz, addressing in groups of six rows means that the maximum duration of a sustain cycle is 21.4 μs. A first level L1 about 2.4 μs in duration, a second level L2 about 5.8 μs in duration, a third level L3 about 10.2 μs in duration and a fourth level L4 about 1.8 μs in duration are used, the transitions T each taking about 0.3 μs. To reduce the duration of the third level, the time separating the address pulses must be reduced.

Referring to the table in FIG. 10, it will be noticed that the number of sustain pulses is increased over the prior art, thereby making it possible to increase the luminosity and the contrast by 50%. In addition, the non-proportionality between the weights of the subscans and the number of pulses is less dispersed than in the previous cases.

According to a third method of implementing the invention, a panel with a coplanar structure, that is to say a panel comprising two row electrodes, is used. FIG. 13 shows such an adaptation.

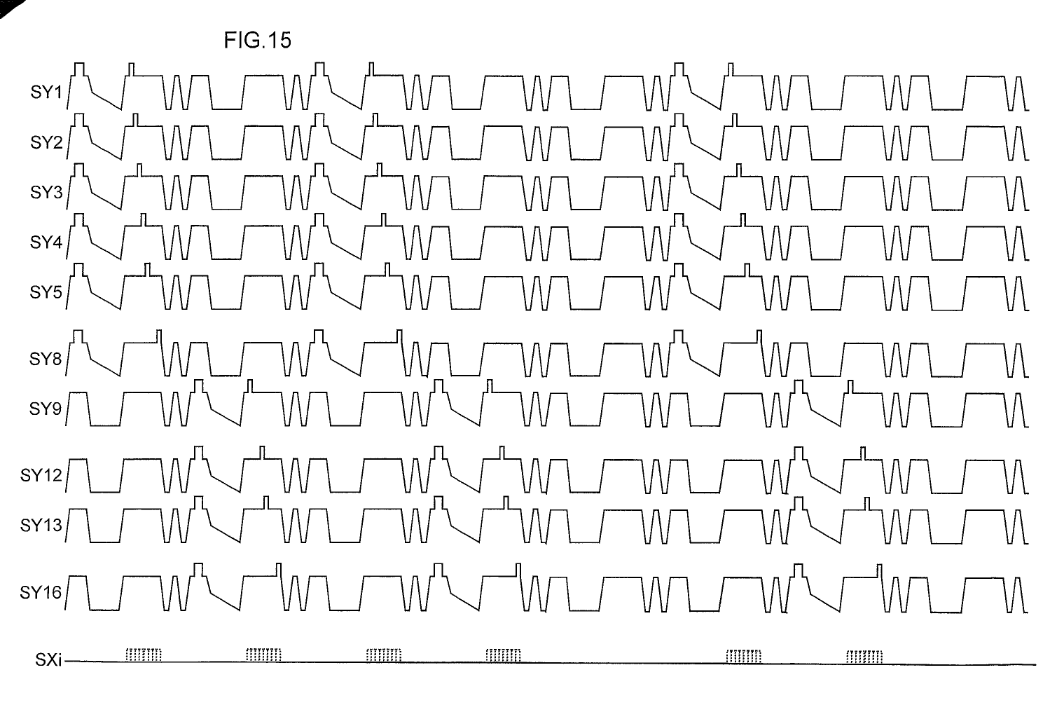

According to a fourth method of implementation, the aim is to increase the luminosity of a PDP. FIG. 14 shows a sustain signal with six levels, which is used for addressing in groups of eight rows. The first to fourth levels L1 to L4 correspond to the levels described above. Fifth and sixth levels L5 and L6 are added after the fourth levels L4. The sole purpose of the fifth and sixth levels L5 and L6 is to add two sustain discharges per cycle. This fourth mode of addressing is shown in FIG. 15 in a more general manner.

As an example, for a 560-line PDP using 10 subscans with images refreshed at a frequency of 50 Hz, addressing in groups of eight rows means that the maximum duration of a sustain cycle is 28.5 μs. A first level L1 of about 2.4 μs in duration, a second level L2 of about 5.7 μs in duration, a third level L3 of about 13.2 μs in duration and fourth to sixth levels about 1.8 μs in duration are used, the transitions T each taking about 0.3 μs. In the table in FIG. 10, a person skilled in the art may see that the number of discharges, and therefore the luminosity, is increased by 50% over the first method of implementation. In addition, the non-proportionality between the weights of the subscans and the number of pulses is less dispersed than in the first method of implementation.

Preferably, the address discharges are placed on the third level L3 so as to obtain the maximum number of sustain discharges per subscan. It is quite possible to place the address pulses on the fifth level L5.

1. Method for driving a plasma display panel, of the AC type, which comprises:
two sealed tiles spaced apart so as to define a cavity between them, one of the tiles supporting column electrodes and the other supporting row electrodes;
illumination cells being located in the cavity, each cell being placed at the intersection of a column electrode with at least one row electrode;
at least one signal generator which delivers to the row electrodes a sustain signal to which ionization pulses, erase pulses and address pulses are added,
in which the ionization pulses and erase pulses are added simultaneously to the sustain signals for at least two rows and in which the address pulses are added simultaneously to a single row,
wherein the sustain signal is a periodic signal which comprises at least first to fourth levels joined by transitions intended to cause sustain discharges,
wherein a first level is immediately followed by a second level and the second level is immediately followed by a third level,
and wherein the ionization pulses are added to the first levels and the erase pulses are added to the second levels.

2. Method according to claim 1, wherein the sustain signal furthermore includes fifth and sixth levels, a fourth, a fifth and a sixth level being placed after the third level and before a next first level, and wherein the first, third and fifth levels correspond to a first voltage and the second, fourth and sixth levels correspond to a second voltage.

3. Method according to claim 1, wherein the address pulses are added to the third levels.

4. Method according to claim 2, wherein the address pulses are added to the third levels.

5. Plasma display panel, of the AC type, which comprises:
two sealed tiles spaced apart so as to define a cavity between them, one of the tiles supporting column electrodes and the other supporting row electrodes;
illumination cells being located in the cavity, each cell being placed at the intersection of a column electrode with at least one row electrode;
at least one signal generator which delivers to the row electrodes a sustain signal to which ionization pulses, erase pulses and address pulses are added,
in which the ionization pulses and erase pulses are added simultaneously to the sustain signals for at least two rows and in which the address pulses are added simultaneously to a single row,
wherein the sustain signal is a periodic signal which comprises at least first to fourth levels joined by transitions intended to cause sustain discharges,
wherein a first level is immediately followed by a second level and the second level is immediately followed by a third level,
and wherein the ionization pulses being added to the first levels and the erase pulses being added to the second levels.

6. Panel according to claim 5, wherein the sustain signal furthermore includes fifth and sixth levels, a fourth, a fifth and a sixth level being placed after the third level and before a next first level, and wherein the first, third and fifth levels correspond to a first voltage and the second, fourth and sixth levels correspond to a second voltage.

7. Panel according to claim 5, wherein the display panel is a matrix panel.

8. Panel according to one of claims 5, wherein the address pulses are added to the third levels.
